(19) United States
(12) Patent Application Publication
(10) Pub. No.: US 2026/0051685 A1
(43) Pub. Date: Feb. 19, 2026

(54) Connector Housing Assembly and Connector

(71) Applicants: TE Connectivity India Private Limited, Bangalore (IN); Tyco Electronics AMP Guangdong Ltd, Foshan City (CN); Tyco Electronics (Shanghai) Co., Ltd., Shanghai (CN)

(72) Inventors: Zhicheng (Sean) Zhang, Shanghai (CN); Jingtao (Murphy) Zhu, Shanghai (CN); Liang (Vincent) Huang, Shanghai (CN); Jun (Herbert) Peng, Foshan (CN); Rakesh K, Bangalore (IN)

(73) Assignees: TE Connectivity India Private Limited, Bangalore (IN); Tyco Electronics AMP Guangdong Ltd, Foshan City (CN); Tyco Electronics (Shanghai) Co., Ltd., Shanghai (CN)

(21) Appl. No.: 19/298,444

(22) Filed: Aug. 13, 2025

(30) Foreign Application Priority Data
Aug. 13, 2024 (CN) 202411114309.3

(51) Int. Cl. H01R 13/24; H01R 12/72; H01R 13/514; H01R 13/6461

(52) U.S. Cl. CPC H01R 13/2492; H01R 12/721; H01R 13/514; H01R 13/6461

(57) ABSTRACT

A connector housing assembly includes a housing and a metal plate provided in the housing. When an upper row of terminals and a lower row of terminals of a connector are provided into the housing, the metal plate is between, and not in contact with, the upper row of terminals and the lower row of terminals. The metal plate reduces signal crosstalk between the upper row of terminals and the lower row of terminals.

### CROSS-REFERENCE TO RELATED APPLICATION

This application claims the benefit of the filing date under 35 U.S.C. § 119 (a)-(d) of Chinese Patent Application No. CN202411114309.3 filed on Aug. 13, 2024, the whole disclosure of which is incorporated herein by reference.

### FIELD OF THE INVENTION

The present invention relates to a connector housing assembly and, more particularly, to a connector housing assembly and a connector comprising the connector housing assembly.

### BACKGROUND OF THE INVENTION

In the prior art, a high-speed signal connector typically includes a housing, an upper row of terminals, and a lower row of terminals. The upper and lower terminals are arranged in the housing and spaced opposite each other in the height direction of the housing. In the prior art, in order to reduce signal crosstalk between the upper and lower terminals, it is necessary to install upper and lower ground connection members in the housing to shorten the connector resonance path and increase the connector resonance frequency. The upper ground connection member is in the form of a strip and is in electrical contact or connection with all ground terminals in the upper row of terminals, while the lower ground connection member is in the form of a strip and is in electrical contact or connection with all ground terminals in the lower row of terminals. The structure and shape of the upper and lower ground connection members in the prior art are relatively complex and difficult to install, which not only increases the cost of the connector but also reduces the manufacturing efficiency of the connector.

### SUMMARY OF THE INVENTION

A connector housing assembly includes a housing and a metal plate provided in the housing. When an upper row of terminals and a lower row of terminals of a connector are provided into the housing, the metal plate is between, and not in contact with, the upper row of terminals and the lower row of terminals. The metal plate reduces signal crosstalk between the upper row of terminals and the lower row of terminals.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a partial exploded view of the connector of FIG. 1;

FIG. 3 is another partial exploded view of the connector of FIG. 1;

FIG. 4 is a longitudinal sectional view of the connector of FIG. 1;

FIG. 5 is a partial exploded sectional view of the connector of FIG. 1;

FIG. 6 is a transverse sectional view of the of FIG. 1;

FIG. 7 is a partial exploded view of a connector according to another exemplary embodiment;

FIG. 8 is a longitudinal sectional view of the connector of FIG. 7;

FIG. 9 is a partial exploded sectional view of the connector of FIG. 7; and

FIG. 10 is a transverse cross-sectional view of the connector of FIG. 7.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

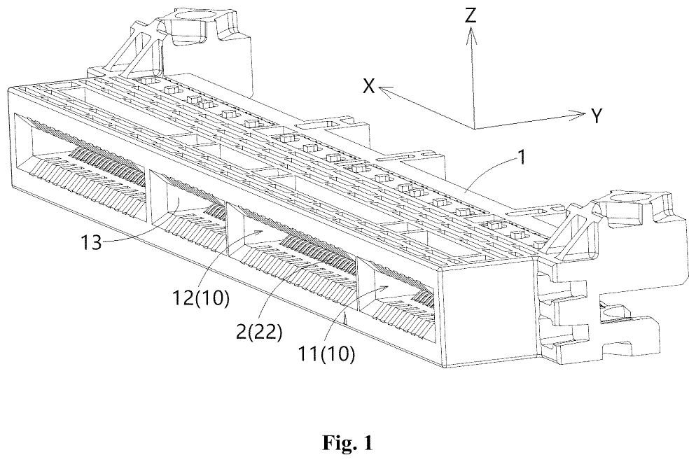

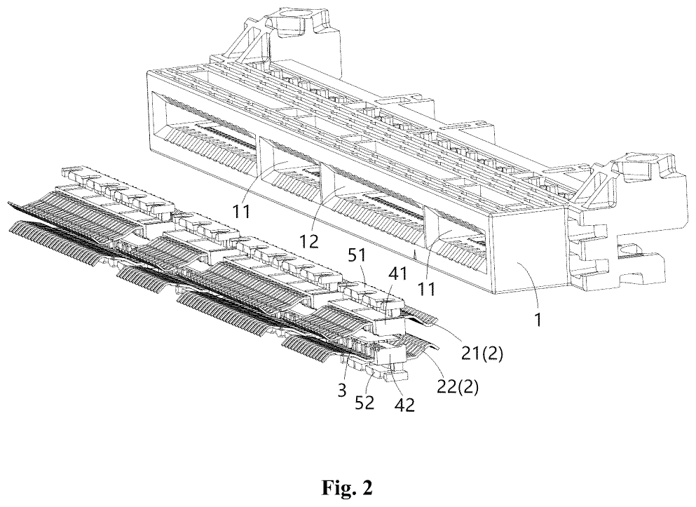

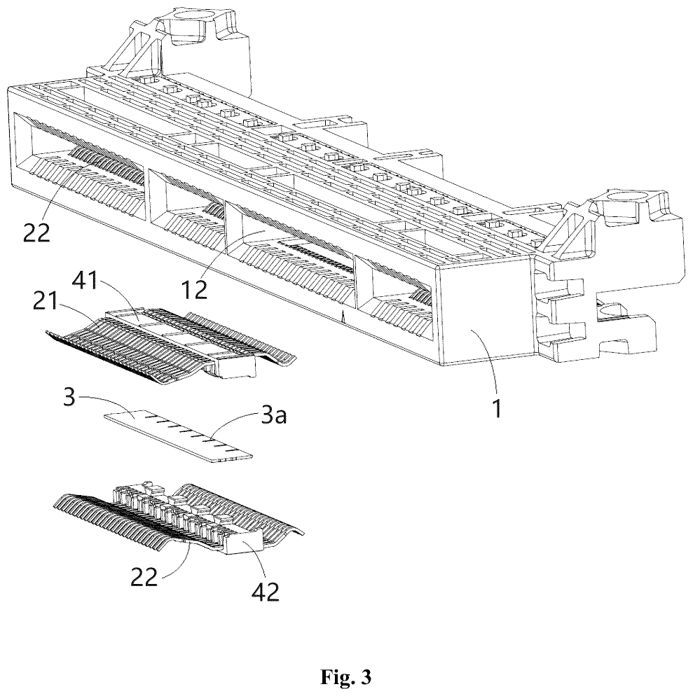

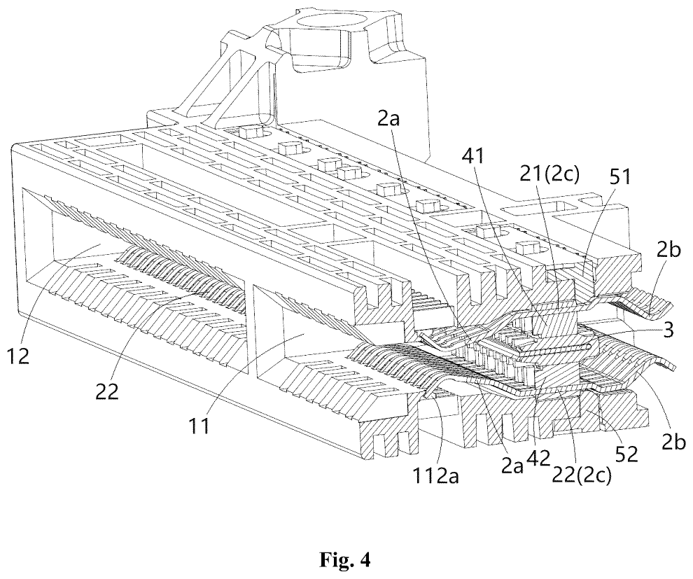

An exemplary embodiment of a connector housing assembly will now be described with reference to FIGS. 1-6. As shown in FIGS. 2-3, the connector housing assembly includes a housing 1 and a metal plate 3. The metal plate 3 is provided in the housing 1. As shown in FIG. 4, when the upper row of terminals 21 and the lower row of terminals 22 of the connector are installed into the housing 1, the metal plate 3 is located between the upper row of terminals 21 and the lower row of terminals 22 and is not in contact with them, in order to reduce signal crosstalk between the upper row of terminals 21 and the lower row of terminals 22.

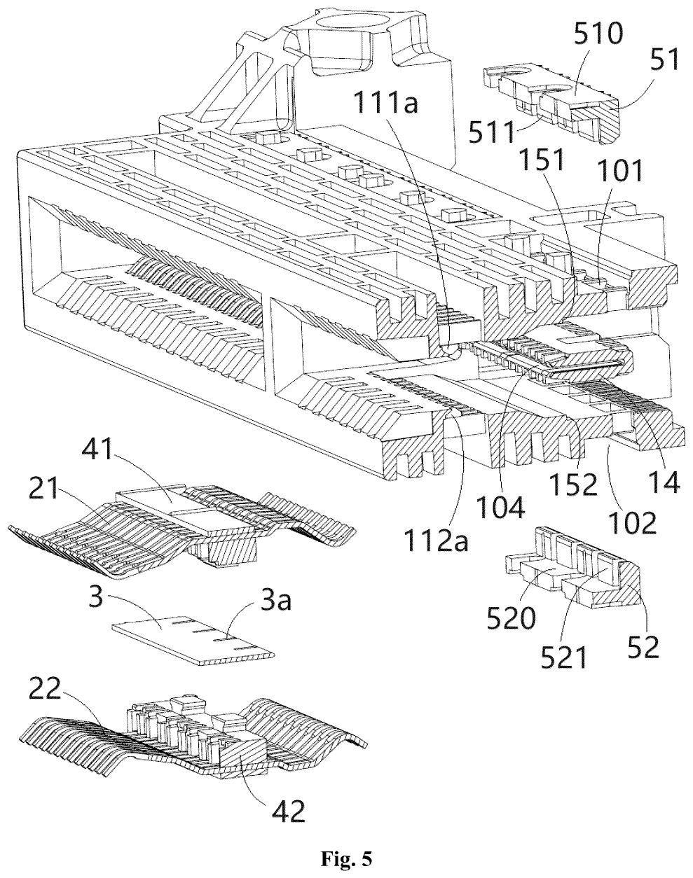

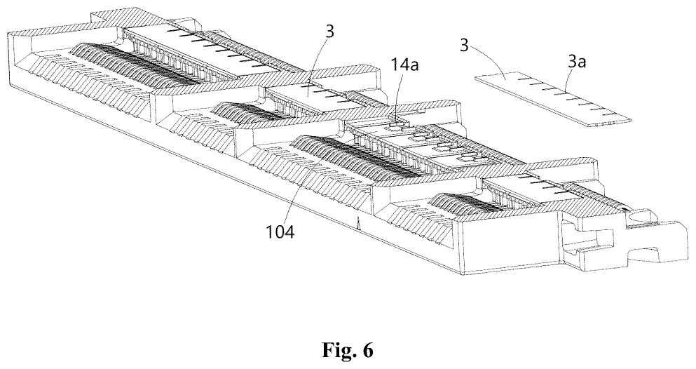

As shown in FIGS. 5-6, a horizontal partition wall 14 is formed in the housing 1. The metal plate 3 is embedded in the horizontal partition wall 14. When the upper row of terminals 21 and the lower row of terminals 22 of the connector are installed into the housing 1, the horizontal partition wall 14 is located between the upper row of terminals 21 and the lower row of terminals 22. As further shown in FIGS. 5-6, a slot 104 is formed in the horizontal partition wall 14. The metal plate 3 is inserted into the slot 104 of the horizontal partition wall 14. The horizontal partition wall 14 extends along the transverse direction X and the longitudinal direction Y of the housing 1, and has opposite front and rear sides in the longitudinal direction Y of the housing 1. The slot 104 has an insertion port formed on the front or rear side of the horizontal partition wall 14, and the metal plate 3 is inserted into the slot 104 through the insertion port.

As shown in FIGS. 3 and 5-6, multiple slits 3a extending along the longitudinal direction Y of the housing 1 are formed in the metal plate 3. The multiple slits 3a are arranged in a row in the transverse direction X of the housing 1, so that the metal plate 3 has a comb tooth shape. As shown in FIG. 6, multiple vertical ribs 14a are formed in the slot 104 of the horizontal partition wall 14. The multiple vertical ribs 14a are respectively inserted into the multiple slits 3a of the metal plate 3 to position and hold the metal plate 3 in the slot 104.

However, the present invention is not limited to the illustrated embodiment. For example, in another exemplary embodiment of the present invention, the housing 1 is an injection molded part formed onto the metal plate 3 through an insert injection molding process, so that the housing 1 and the metal plate 3 become an integral piece. As another example, the metal plate 3 may be a single metal plate 3 continuously extending between the left and right side walls opposite to the transverse X of the housing 1. The housing 1 can be an injection molded part formed onto the metal plate 3 through an insert injection molding process, making the housing 1 and the metal plate 3 an integral piece.

As shown in FIG. 1, in the illustrated embodiment, at least one vertical partition wall 13 is formed in the housing 1, which divides the inner cavity 10 of the housing 1 into multiple sub cavities 11, 12. The multiple sub cavities 11 and 12 are arranged side by side in the transverse direction X of the housing 1, and one metal plate 3 is provided in each sub cavity 11 and 12 of the housing 1. As shown in FIGS. 1-2, the multiple sub cavities 11 and 12 include first and second sub cavities 11 and 12 alternately arranged in the transverse direction X of the housing 1. The size of the first sub cavity 11 in the transverse direction X of the housing 1 is different from that of the second sub cavity 12 in the transverse direction X.

An exemplary embodiment of a connector will now be described with reference to FIGS. 1-6. As shown in FIGS. 2-4, the connector includes the aforementioned connector housing assembly, an upper row of terminals 21, and a lower row of terminals 22. The upper row of terminals 21 and the lower row of terminals 22 are provided in the housing 1. As shown in FIG. 4, the metal plate 3 is located between the upper row of terminals 21 and the lower row of terminals 22 and is not in contact with them, used to reduce signal crosstalk between the upper row of terminals 21 and the lower row of terminals 22.

As shown in FIGS. 4-5, the connector further comprises an upper holder 41 and a lower holder 42. The upper holder 41 is used to hold the upper row of terminals 21 and is inserted into the housing 1. The lower holder 42 is used to hold the lower row of terminals 22 and is inserted into the housing 1. The horizontal partition wall 14 of the housing 1 is located between the upper holder 41 and the lower holder 42 and separates the upper holder 41 from the lower holder 42. The upper holder 41 is an injection molded part formed onto the upper row of terminals 21 through an insert injection molding process, so that the upper holder 41 and the upper row of terminals 21 become an integral piece. Similarly, the lower holder 42 is an injection molded part formed onto the lower row of terminals 22 through an insert injection molding process, making the lower holder 42 and the lower row of terminals 22 an integral piece.

As shown in FIG. 4, each terminal 21,22 of the upper row of terminals 21 and the lower row of terminals 22 includes a front elastic arm 2a, a rear elastic arm 2b, and a fixed portion 2c connected between the front elastic arm 2a and the rear clastic arm 2b. The fixed portions 2c of the upper row of terminals 21 are fixed in the upper holder 41, and the fixed portions 2c of the lower row of terminals 22 are fixed in the lower holder 42.

As shown in FIGS. 1-6, the housing 1 has front and rear ports that are opposite in its longitudinal direction Y. As shown in FIG. 4, the front elastic arms 2a of the upper row of terminals 21 and the lower row of terminals 22 are located in the front port of the housing 1, and the rear elastic arms 2b of the upper row of terminals 21 and the lower row of terminals 22 are located in or extends from the rear port of the housing 1. The front elastic arms 2a of the upper row of terminals 21 and the front elastic arms 2a of the lower row of terminals 22 are spaced opposite each other in the height direction Z of the housing 1, for electrical contact with two sides of a first circuit card inserted between them. The rear elastic arms 2b of the upper row of terminals 21 and the rear clastic arms 2b of the lower row of terminals 22 are spaced opposite each other in the height direction Z of the housing 1, for electrical contact with two sides of a second circuit card inserted between them.

As shown in FIG. 5, a row of upper positioning slots 111a and a row of lower positioning slots 112a are formed in the inner sides of the top and bottom walls of the housing 1, respectively. The ends of the front elastic arms 2a of the upper row of terminals 21 are respectively positioned in the row of upper positioning slots 111a, and the ends of the front elastic arms 2a of the lower row of terminals 22 are respectively positioned in the row of lower positioning slots 112a.

The upper holder 41 is inserted between the top wall of the housing 1 and the horizontal partition wall 14, and the lower holder 42 is inserted between the bottom wall of the housing 1 and the horizontal partition wall 14. As shown in FIG. 5, an upper step portion 151 is formed on the inner side of the top wall of housing 1. The upper step portion 151 is pressed against the front end of the upper holder 41, for longitudinally positioning the upper holder 41 and the upper row of terminals 21. A lower step portion 152, as shown in FIG. 5, is formed on the inner side of the bottom wall of the housing 1, which is pressed against the front end of the lower holder 42, to longitudinally position the lower holder 42 and the lower row of terminals 22.

As shown in FIG. 5, an upper mounting slot 101 and a lower mounting slot 102 are respectively formed in the top and bottom walls of the housing 1, which are communicated with the inner cavity 10 of the housing 1. The connector also includes, as shown in FIG. 5, an upper locking block 51 and a lower locking block 52. The upper locking block 51 is inserted into the upper mounting slot 101 of the housing 1 and pressed against the rear end of the upper holder 41 to lock the upper holder 41 in the housing 1. The lower locking block 52 is inserted into the lower mounting slot 102 of the housing 1 and pressed against the rear end of the lower holder 42 to lock the lower holder 42 in the housing 1.

As shown in FIG. 1, at least one vertical partition wall 13 is formed in the housing 1, which divides the inner cavity 10 of the housing 1 into multiple sub cavities 11, 12. The multiple sub cavities 11, 12 are arranged side by side in the transverse direction X of the housing 1, and the upper row of terminals 21, the lower row of terminals 22, and the metal plate 3 are provided in each sub cavity 11, 12 of the housing 1.

As shown in FIGS. 1-2, the multiple sub cavities 11 and 12 include first and second sub cavities 11 and 12 alternately arranged in the transverse direction X of the housing 1. The size of the first sub cavity 11 in the transverse direction X of the housing 1 is different from that of the second sub cavity 12 in the transverse direction X of the housing 1, so that the number of upper row of terminals 21 and lower row of terminals 22 arranged in the first sub cavity 11 is different from the number of upper row of terminals 21 and lower row of terminals 22 arranged in the second sub cavity 12. For example, the number of upper row of terminals 21 and lower row of terminals 22 in the first sub cavity 11 can be 10, and the number of upper row of terminals 21 and lower row of terminals 22 in the second sub cavity 11 can be 20.

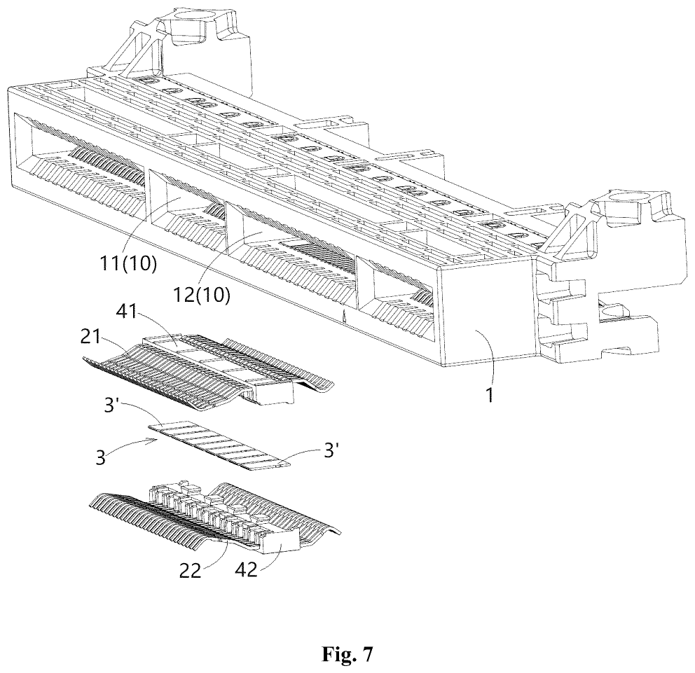

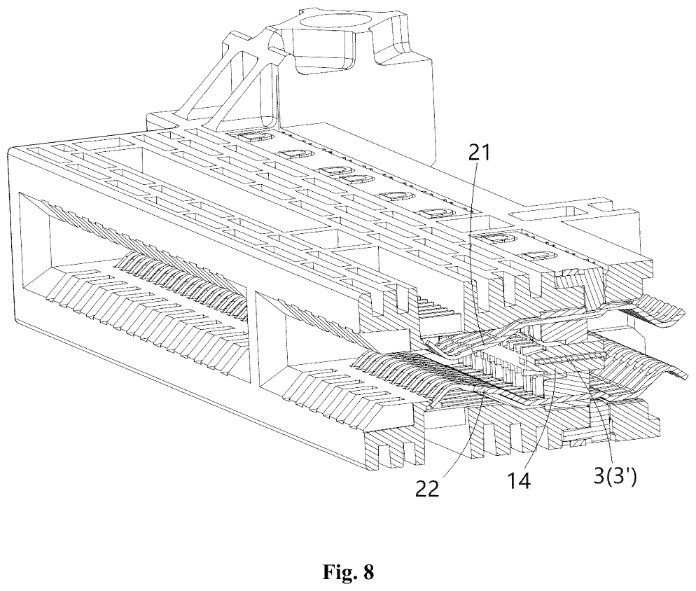

Another embodiment of a connector housing assembly will now be described with reference to FIGS. 7-10. A difference between the connector housing assembly according to FIGS. 7-10 and the connector housing assembly according to FIGS. 1-6 is the structure of the metal plate 3.

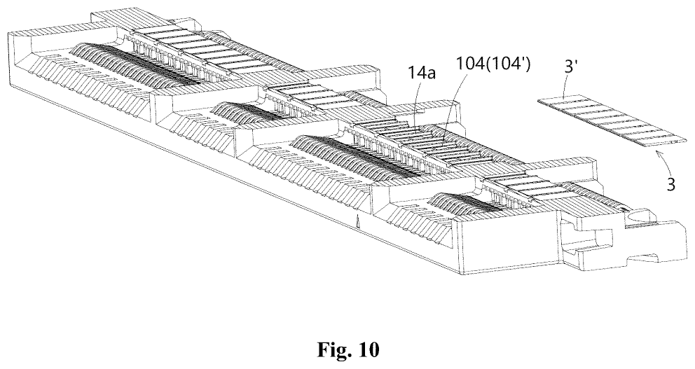

As shown in FIG. 10, multiple vertical ribs 14a extending along the longitudinal direction Y of the housing 1 are formed in the slot 104 of the horizontal partition wall 14 of the housing 1. The multiple vertical ribs 14a divide the slot 104 into multiple sub slots 104′. The metal plate 3 includes multiple sub metal plates 3′, as shown in FIGS. 7-10, arranged side by side in the transverse direction X of the housing 1. The multiple sub metal plates 3′ are respectively inserted into multiple sub slots 104′.

Additionally, the insertion port of the slot 104, of the connector housing assembly according to FIGS. 7-10, is formed on the rear side of the horizontal partition wall 14, and the metal plate 3 is inserted into the slot 104 from the insertion port on the rear side of the horizontal partition wall 14. In contrast, the insertion port of the slot 104, of the connector housing assembly according to FIGS. 1-6, is formed on the front side of the horizontal partition wall 14, and the metal plate 3 is inserted into the slot 104 from the insertion port on the front side of the horizontal partition wall 14.

Except for the aforementioned differences, the other technical features of the connector housing assembly according to FIGS. 7-10 are basically the same as those of the connector housing assembly according to FIGS. 1-6. For the sake of simplicity, this article will not repeat them, and reference can be made to the connector housing assembly according to FIGS. 1-6.

An exemplary embodiment of a connector will now be described with reference to FIGS. 1-10. The connector includes a housing 1, according to FIGS. 1-6 or FIGS. 7-10, an upper row of terminals 21, an upper holder 41, a lower row of terminals 22, a lower holder 42, an upper locking block 51, and a lower locking block 52. As shown in FIG. 5, an upper mounting slot 101 and a lower mounting slot 102 are respectively formed in the top and bottom walls of housing 1, which are communicated with its inner cavity 10. The upper row of terminals 21 is provided in the inner cavity 10 of the housing 1. The upper holder 41 is used to hold the upper row of terminals 21 and is inserted into the inner cavity 10 of the housing 1. The lower row of terminals 22 is provided in the inner cavity 10 of the housing 1. The lower holder 42 is used to hold the lower row of terminals 22 and is inserted into the inner cavity 10 of the housing 1. The upper locking block 51 is inserted into the upper mounting slot 101 of the housing 1 and pressed against the rear end of the upper holder 41 to lock the upper holder 41 in the housing 1. The lower locking block 52 is inserted into the lower mounting slot 102 of the housing 1 and rest against the rear end of the lower holder 42 to lock the lower holder 42 in the housing 1.

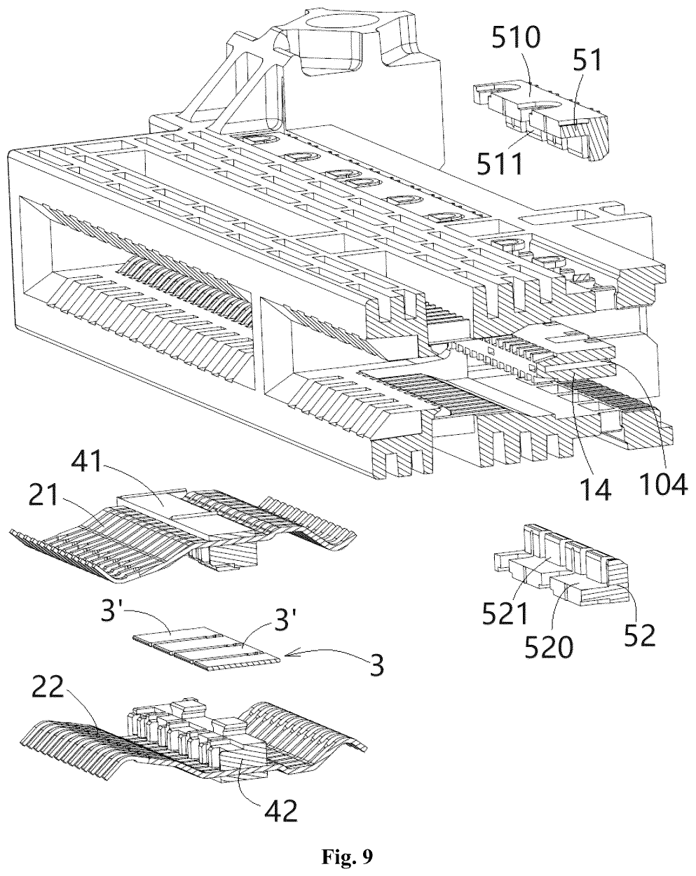

As shown in FIGS. 5 and 9, the upper locking block 51 includes an upper strip-shaped body 510 and a row of upper teeth 511. The upper strip-shaped body 510 extends along the transverse direction X of the housing 1. The row of upper teeth 511 is connected to the upper strip-shaped body 510. The row of upper teeth 511 is tightly pressed against the rear end of the upper holder 41 along the longitudinal direction Y of the housing 1, so that there is no gap between the two. The upper row of terminals 21 includes a ground terminal and a signal terminal, and the upper tooth 511 spans between the ground terminal and the signal terminal of the upper row of terminals 21 or between the signal terminal and the signal terminal of the upper row of terminals 21. The upper teeth 511 and the upper row of terminals 21 are adjacent to each other in the height direction Z of the housing 1, such that the distance between the two is less than a predetermined value.

As shown in FIGS. 5 and 9, the lower locking block 52 includes a lower strip-shaped body 520 and a row of lower teeth 521. The lower strip-shaped body 520 extends along the transverse direction X of the housing 1. The row of lower teeth 521 is connected to the lower strip-shaped body 520. The row of lower teeth 521 is tightly pressed against the rear end of the lower holder 42 along the longitudinal direction Y of the housing 1, so that there is no gap between the two. The lower row of terminals 22 includes a ground terminal and a signal terminal, and the lower tooth 521 spans between the ground terminal and the signal terminal of the lower row of terminals 22 or between the signal terminal and the signal terminal of the lower row of terminals 22. The lower teeth 521 and the lower row of terminals 22 are adjacent to each other in the height direction Z of the housing 1, such that the distance between the two is less than a predetermined value.

The upper holder 41, as shown in FIGS. 2-5, 7, and 9, is an injection molded part formed onto the upper row of terminals 21 through an insert injection molding process, so that the upper holder 41 and the upper row of terminals 21 become an integral piece. Similarly, the lower holder 42, as shown in FIGS. 2-5, 7, and 9, is an injection molded part formed onto the lower row of terminals 22 through an insert injection molding process, making the lower holder 42 and the lower row of terminals 22 an integral piece.

As shown in FIGS. 2-10, the connector further comprises a metal plate 3. The metal plate 3 is provided in the housing 1. The metal plate 3 is located between the upper row of terminals 21 and the lower row of terminals 22 and is not in contact with them. The metal plate 3 is used to reduce signal crosstalk between the upper row of terminals 21 and the lower row of terminals 22.

In the aforementioned exemplary embodiments according to the present invention, the metal plate 3 provided in the housing 1 can effectively reduce signal crosstalk between the upper row of terminals 21 and the lower row of terminals 22, and improve the signal integrity of the connector. Moreover, the structure of the metal plate 3 is simple, easy to manufacture, and install, which can reduce the cost of the connector and improve the manufacturing efficiency of the connector. Further, the upper holder 41 and the lower holder 42 are reliably locked in the housing 1 by the upper locking block 51 and the lower locking block 52, respectively, so that the upper holder 41 and the lower holder 42 cannot move relative to the housing 1, and the gap between the terminals 21,22 and the housing 1 does not change, thereby improving the signal integrity performance of the connector. Additionally, the upper tooth 511 of the upper locking block 51 spans between the ground terminal and signal terminal of the upper row of terminals 21 or between the signal terminals of the upper row of terminals 21 and maintains a close distance from the upper row of terminals 21, thereby adjusting the capacitance and inductance of the signal to ground or signal to signal to achieve excellent signal integrity performance. Furthermore, the lower tooth 521 of the lower locking block 521 spans between the ground terminal and signal terminal of the lower row of terminals 22 or between the signal terminals of the lower row of terminals 22 and maintains a close distance from the lower row of terminals 22, thereby adjusting the capacitance and inductance of the signal to ground or signal to signal to achieve excellent signal integrity performance.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector housing assembly, comprising:
a housing; and
a metal plate provided in the housing, when an upper row of terminals and a lower row of terminals of a connector are provided into the housing, the metal plate is between, and not in contact with, the upper row of terminals and the lower row of terminals, the metal plate reduces signal crosstalk between the upper row of terminals and the lower row of terminals.

2. The connector housing assembly of claim 1, wherein a horizontal partition wall is formed in the housing, the metal plate is embedded in the horizontal partition wall, when the upper row of terminals and the lower row of terminals are provided into the housing, the horizontal partition wall is between the upper row of terminals and the lower row of terminals.

3. The connector housing assembly of claim 2, wherein a slot is formed in the horizontal partition wall, the metal plate is inserted into the slot.

4. The connector housing assembly of claim 3, wherein the horizontal partition wall extends along a transverse direction and a longitudinal direction of the housing, and has opposite front and rear sides in the longitudinal direction, the slot has an insertion port formed on the front or rear side of the horizontal partition wall, and the metal plate is inserted into the slot through the insertion port.

5. The connector housing assembly of claim 4, wherein a plurality of slits extending along the longitudinal direction are formed in the metal plate, each slit is arranged in a row in the transverse direction of the housing such that the metal plate has a comb tooth shape, and a plurality of vertical ribs are formed in the slot of the horizontal partition wall, each vertical rib is inserted into one slit to position and hold the metal plate in the slot.

6. The connector housing assembly of claim 4, wherein a plurality of vertical ribs extending along the longitudinal direction are formed in the slot of the horizontal partition wall, which divides the slot into a plurality sub slots, the metal plate has a plurality of sub metal plates arranged side by side in the transverse direction, each sub metal plate is inserted into one sub slot.

7. The connector housing assembly of claim 1, wherein the housing is an injection molded part formed onto the metal plate through an insert injection molding process, the housing and the metal plate are an integral piece.

8. The connector housing assembly of claim 7, wherein the metal plate is a single metal plate that extends continuously between a left side wall of the housing and a right side wall of the housing opposite to each other in a transverse direction of the housing.

9. The connector housing assembly of claim 1, wherein the connector housing assembly has a plurality of metal plates and at least one vertical partition wall is formed in the housing, the at least one vertical partition wall divides an inner cavity of the housing into a plurality of sub cavities, each sub cavity is arranged side by side in a transverse direction of the housing, each metal plate is provided in one sub cavity.

10. The connector housing assembly of claim 9, wherein each sub cavity includes a first sub cavity and a second sub cavity alternately arranged in the transverse direction, a size of the first sub cavity in the transverse direction is different from a size of the second sub cavity in the transverse direction.

11. A connector, comprising:
a connector housing assembly including a housing and a metal plate provided in the housing;
an upper row of terminals provided in the housing; and
a lower row of terminals provided in the housing, the metal plate is between, and not in contact with, the upper row of terminals and the lower row of terminals, the metal plate reduces signal crosstalk between the upper row of terminals and the lower row of terminals.

12. The connector of claim 11, further comprising an upper holder and a lower holder, the upper holder is inserted into the housing and holds the upper row of terminals, the lower holder is inserted into the housing and holds the lower row of terminals, a horizontal partition wall of the housing between the upper holder and the lower holder separates the upper holder from the lower holder.

13. The connector of claim 12, wherein the upper holder is an injection molded part formed onto the upper row of terminals through an insert injection molding process, and the upper holder and the upper row of terminals are an integral piece, and/or the lower holder is an injection molded part formed onto the lower row of terminals through an insert injection molding process, the lower holder and the lower row of terminals are an integral piece.

14. The connector of claim 12, wherein each terminal in the upper row of terminals and the lower row of terminals has a front elastic arm, a rear elastic arm, and a fixing portion connected between the front elastic arm and the rear elastic arm, each fixing portion of each terminal in the upper row of terminals are fixed in the upper holder, and each fixing portion of each terminal in the lower row of terminals are fixed in the lower holder, and the housing has a front port and a rear port that are opposite in a longitudinal direction of the housing, each front elastic arm of each terminal in the upper row of terminals and the lower row of terminals are in the front port, and each rear elastic arm of each terminal in the upper row of terminals and the lower row of terminals are in, or extend from, the rear port.

15. The connector of claim 14, wherein each front elastic arm of each terminal in the upper row of terminals and each front elastic arm in each terminal of the lower row of terminals are spaced opposite each other in a height direction of the housing, and electrically contacts two sides of a first circuit card inserted between each front elastic arm of each terminal in the upper row of terminals and the lower row of terminals, and/or each rear elastic arm of each terminal in the upper row of terminals and each rear elastic arm of each terminal in the lower row of terminals are spaced opposite each other in the height direction, and electrically contacts two sides of a second circuit card inserted between each rear elastic arm of each terminal in the upper row of terminals and the lower row of terminals.

16. The connector of claim 14, wherein a row of upper positioning grooves is formed on an inner side of a top wall of the housing, and a row of lower positioning grooves is formed on an inner side of a bottom wall of the housing, an end of each front elastic arm of each terminal in the upper row of terminals are positioned in one positioning groove of the row of upper positioning grooves, and each end of each front elastic arm of each terminal in the lower row of terminals are positioned in one positioning groove of the row of lower positioning grooves.

17. The connector of claim 12, wherein the upper holder is inserted between a top wall of the housing and the horizontal partition wall, and the lower holder is inserted between a bottom wall of the housing and the horizontal partition wall, an upper step portion is formed on an inner side of the top wall of the housing, the upper step portion is pressed against a front end of the upper holder, to longitudinally position the upper holder and the upper row of terminals, and a lower step portion is formed on an inner side of the bottom wall of the housing, the lower step portion is pressed against a front end of the lower holder, to longitudinally position the lower holder and the lower row of terminals.

18. The connector of claim 17, wherein an upper mounting slot is formed in the top wall of the housing and a lower mounting slot is formed in the bottom wall of the housing, the upper mounting slot and the lower mounting slot are in communication with an inner cavity of the housing, and the connector further comprises an upper locking block and a lower locking block, the upper locking block is inserted into the upper mounting slot and pressed against a rear end of the upper holder to lock the upper holder in the housing, and the lower locking block is inserted into the lower mounting slot and pressed against a rear end of the lower holder to lock the lower holder in the housing.

19. The connector of claim 11, wherein at least one vertical partition wall is formed in the housing, which divides an inner cavity of the housing into a plurality of sub cavities, each sub cavity is arranged side by side in a transverse direction of the housing, the upper row of terminals, the lower row of terminals, and the metal plate are each provided in one sub cavity.

20. The connector of claim 19, wherein each sub cavity includes a first sub cavity and a second sub cavity alternately arranged in the transverse direction, a size of the first sub cavity in the transverse direction is different from a size of the second sub cavity in the transverse direction, such that a number of the upper row of terminals and the lower row of terminals in the first sub cavity is different from a number of the upper row of terminals and the lower row of terminals in the second sub cavity.

21. A connector, comprising:
a housing having an upper mounting slot formed in a top wall of the housing and a lower mounting slot formed in a bottom wall of the housing, the upper mounting slot and the lower mounting slot are in communication with an inner cavity of the housing;
an upper row of terminals provided in the inner cavity;
an upper holder inserted into the inner cavity and holding the upper row of terminals;
a lower row of terminals provided in the inner cavity;
a lower holder inserted into the inner cavity and holding the lower row of terminals;
an upper locking block inserted into the upper mounting slot and pressed against a rear end of the upper holder to lock the upper holder in the housing; and
a lower locking block inserted into the lower mounting slot and pressed against a rear end of the lower holder to lock the lower holder in the housing.

22. The connector of claim 21, wherein the upper locking block has an upper strip-shaped body which extends along a transverse direction of the housing and a row of upper teeth connected to the upper strip-shaped body, the row of upper teeth is tightly pressed against the rear end of the upper holder along a longitudinal direction of the housing such that there is no gap between the row of upper teeth and the rear end of the upper holder.

23. The connector of claim 22, wherein the upper row of terminals includes at least one ground terminal and at least one signal terminal, an upper tooth of the row of upper teeth spans between the ground terminal and the signal terminal or between two signal terminals of the upper row of terminals.

24. The connector of claim 23, wherein the row of upper teeth and the upper row of terminals are adjacent to each other in a height direction of the housing, such that a distance between the row of upper teeth and the upper row of terminals is less than a predetermined value.

25. The connector of claim 21, wherein the lower locking block has a lower strip-shaped body extending along a transverse direction of the housing and a row of lower teeth connected to the lower strip-shaped body, the row of lower teeth is tightly pressed against a rear end of the lower holder along a longitudinal direction of the housing such that there is no gap between the row of lower teeth and the lower holder.

26. The connector of claim 25, wherein the lower row of terminals include at least one ground terminal and at least one signal terminal, a lower tooth of the row of lower teeth spans between the ground terminal and the signal terminal or between two signal terminals of the lower row of terminals.

27. The connector of claim 26, wherein the row of lower teeth and the lower row of terminals are adjacent to each other in a height direction of the housing, such that a distance between the row of lower teeth and the lower row of terminals is less than a predetermined value.

28. The connector of claim 21, wherein the upper holder is an injection molded part formed onto the upper row of terminals through an insert injection molding process, and the upper holder and the upper row of terminals are an integral piece, and/or the lower holder is an injection molded part formed onto the lower row of terminals through an insert injection molding process, the lower holder and the lower row of terminals are an integral piece.

29. The connector according to claim 21, further comprising a metal plate provided in the housing, the metal plate is between, and not in contact with, the upper row of terminals and the lower row of terminals, the metal plate reduces signal crosstalk between the upper row of terminals and the lower row of terminals.
